(19) United States
(12) Patent Application Publication
(10) Pub. No.: US 2007/0069020 A1
(43) Pub. Date: Mar. 29, 2007

(54) Transponder Unit

(76) Inventors: Luca Baraldi, Zollikofen (CH); Reto Eggimann, Brugg (CH); Jorg Hehlgans, Diekholzen (DE); Christian Patry, Kerzers (CH)

Correspondence Address: HAYES, SOLOWAY P.C., 3450 E. SUNRISE DRIVE, SUITE 140, TUCSON, AZ, 85718, US

(21) Appl. No.: 11/536,396

(22) Filed: Sep. 28, 2006

(30) Foreign Application Priority Data
Sep. 29, 2005 (DE) 20 2005 015 382.6
May 2, 2006 (DE) 20 2006 006 954.2

(51) Int. Cl. H04Q 5/22; G06K 7/00

(52) U.S. Cl. 235/435; 340/10.1

(57) ABSTRACT

In order to realize a cost-effective production of a transponder in an RFID system that is intended for the identification of merchandise, the invention proposes a two-part housing with an upper housing part and a lower housing part, wherein the lower housing part is provided with a grounding surface and an antenna with a transponder IC is spaced apart from and arranged above this grounding surface.

### FIELD OF THE INVENTION

The invention pertains to a transponder unit in a hermetically sealed housing that consists of a lower housing part and an upper housing part.

### BACKGROUND OF THE INVENTION

The development of Radio Frequency Identification Systems (RFID) has advanced significantly in the last few years. RFID systems are used, e.g., for the identification of merchandise in department stores as well as in the fields of logistics and control or automation technology. In accordance with the industrial environment, these systems are subject to strict requirements with respect to reliability and ease of operation. A broad variety of designs is available. These systems are produced in the form of printed labels, ISO cards, key fobs, etc.

RFID systems consist of a transmission module (transponder) with stored data, wherein the transponder is composed of one or more integrated circuits (transponder ICs), an antenna and other passive components.

The system furthermore requires a reception module or a reader for the data acquisition.

The transponder is attached to the merchandise to be monitored. In this case, the distance between the transponder and the reader (reading distance) depends on the transmission system and the frequency used. RFID systems can be operated within Europe on the so-called SRD band between 868 and 870 MHz (recently also between 865 and 868 MHz) and worldwide between 2400 and 2483.5 MHz.

In passive systems, the transponder is supplied with energy by a magnetic or electromagnetic field. Due to the external energy supply, the design can be realized in a very simple and cost-effective fashion.

The field of application of a transponder essentially depends on the reading distance and the properties of the housing. In order to achieve the broadest range of applications possible, the housing should be realized as small as possible and insensitive to environmental influences.

In addition, an unrestricted function needs to be ensured on conductive, absorbing or reflecting surfaces.

Transponders are produced in different variations. The shape of the transponder is essentially defined by the antenna. The antennas are punched, etched or produced by means of conventional circuit board technology and installed into corresponding housings, Different technologies may be employed for producing the connection between the antenna and the transponder IC: transponder ICs with leadframe can be contacted by means of soldering, microwelding or crimping. Transponder ICs without a dedicated housing can be directly connected by means of bonding or soldering.

The production process of a transponder can be broken down into the following production steps: Installation and adjustment of the antenna and the transponder IC Into the housing. Contacting the transponder IC with the antenna and the grounding surface. Introducing a dielectric and closing the housing by means of screws, bonding or welding.

In this context, it is disadvantageous that installation and adjustment errors have negative effects on the operational reliability and efficiency of the transponder. If different materials are joined together, the stability and dimensional accuracy also cannot be ensured under significant temperature fluctuations and external mechanical stresses because components with different properties are connected to one another. Furthermore, adaptations to changing external conditions can only be realized by modifying the components, wherein a new construction is required in many instances.

### SUMMARY OF THE INVENTION

The invention is based on the objective of developing a transponder of the initially mentioned type in such a way that installation and adjustment errors can be precluded by producing the conductor body, the antenna and the grounding surface from one piece.

This objective is attained in that the lower housing part is provided with a grounding surface, and in that an antenna is arranged a certain distance from the grounding surface,

The advantages attained with the invention can be seen, in particular, in that a higher precision and a superior reproducibility are ensured in the manufacture of the entire housing due to a special shaping technique. In this case, the antenna may be realized in the form of a one-piece web that is integrally moulded to and spaced apart from the lower housing side, wherein a strip-shaped antenna is applied on said web.

The antenna may furthermore be integrated into the upper housing side in the form of a metallized strip.

It is advantageous that no antenna installation and adjustment processes are required in these respective instances.

The conductive, metallized antenna strips in the upper part and the grid-like or planar grounding surface in the lower part are produced by means of selective metallization.

The grounding surface may be applied on the inside or the outside of the lower housing side in this case.

In addition, the introduction of a dielectric into the space between the upper housing side and the lower housing side advantageously influences the stability of the housing as well as the radiation characteristic of the transponder.

The realization of the housing with corresponding installation aids such as bores, slots and form-fitted bonding surfaces allows a simple installation on arbitrary objects. Consequently, the transponder is suitable for use on all installation surfaces and can also be reliably utilized in the industrial environment.

### BRIEF DESCRIPTION OF THE DRAWINGS

One embodiment of the invention is illustrated in the figures and described in greater detail below. The figures show:

FIG. 1, a perspective representation of a transponder unit consisting of a lower housing part and an upper housing part;

FIG. 2, a perspective representation of the inner side of the upper housing part;

FIG. 3, a perspective representation of a variation of the transponder unit, and

FIG. 4, a perspective representation of the lower housing part of FIG. 3.

### DETAILED DESCRIPTION OF THE INVENTION

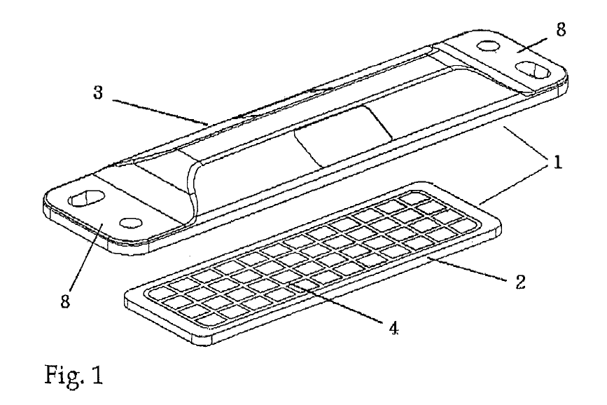

FIG. 1 shows a transponder unit 1 with a lower housing part 2 and an upper housing part 3. The upper housing part features installation aids 8 in the form of bores and/or slots that simplify the attachment of the transponder to arbitrary objects.

The grounding surface 4 on the lower housing part 2 consists of intersecting metal strips such that a grid is formed. However, the grounding surface could also be realized in a planar fashion.

The lower housing part 2 is fitted into a corresponding annular recess 10 in the upper housing part 3 in the form of a complete unit and preferably welded thereto such that a seamless transition is realized between the laterally protruding surfaces of the mounting aids 8 and the lower housing part 2.

However, no electrically conductive connections are produced between the upper housing side and the lower housing side.

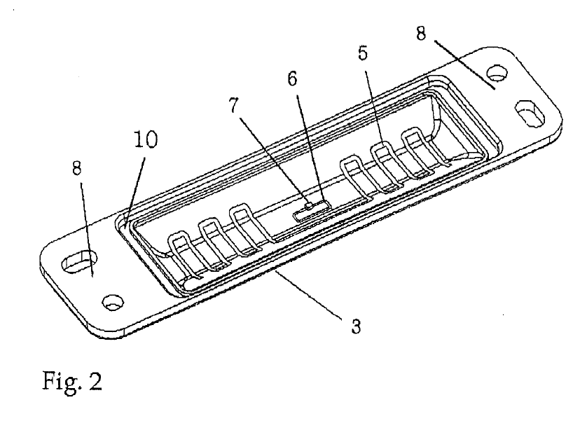

FIG. 2 shows a perspective representation of the inner side of the upper housing part 3 of the transponder unit 1.

Meander-shaped metallic strips applied on the outwardly curved inner side form an antenna 5.

In this case, the antenna is directly applied on the upper housing part without an adhesive such that deformations under thermal and mechanical stresses are significantly reduced and long-term dimensional stability is ensured.

The metallic strips of the antenna do not lie in one plane, but rather are adapted to the shape of the housing such that the available space is optimally utilized and the design and calibration of the antenna can be realized in a highly flexible fashion.

The transponder IC 7 is arranged about centrally in the upper housing side 3, wherein the antenna 5 is supplied via a coupling loop 6 that is connected to the IC 7.

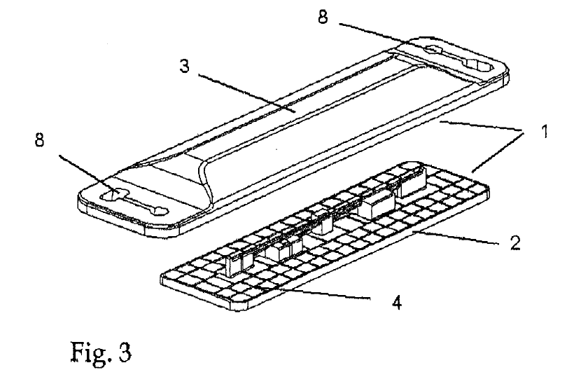

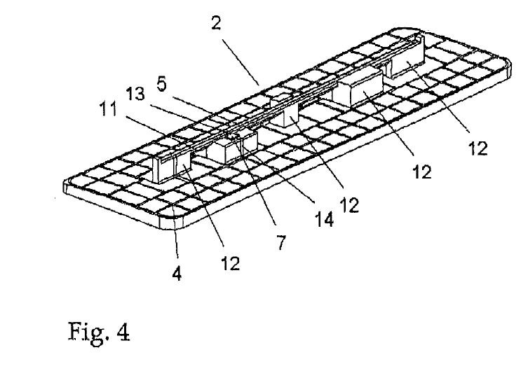

FIGS. 3, 4 show a variation of the transponder unit, in which identical elements are identified by the same reference symbols as in the above-described embodiment.

FIG. 3 shows a transponder unit 1 with a lower housing part 2 and an upper housing part 3. The upper housing part features installation aids 8 in the form of bores and/or slots that simplify the attachment of the transponder to arbitrary objects.

FIG. 4 shows a perspective representation of the lower housing part 2 of the transponder unit 1. In this case, a web 11 with several spacer elements 12 is arranged on the lower housing part by means of a so-called casting method.

A metallic strip applied on the web 11 forms an antenna 5. The lower housing part 2 features a grid-like grounding surface 4 that, however, could also be realized in the form of a planar surface.

A transponder IC 7 arranged on one of the spacer elements 12 is connected to the antenna 5 and the conductor element 13 on one hand and to the conductor element 14 and the grounding surface 4 on the other hand.

### LIST OF REFERENCE SYMBOLS

1 Transponder unit
2 Lower housing part
3 Upper housing part
4 Grounding surface, grid-like
Antenna, metal strips
6 Coupling loop
7 Transponder IC
8 Installation aid
9
10 Recess In upper housing part, annular
11 Web
12 Spacer element
13 Conductor element, A
14 Conductor element, M
15

What is claimed is:

1. A transponder unit in a hermetically sealed housing that consists of an upper housing part and a lower housing part, wherein
the lower housing part is provided with a grounding surface, and in that an antenna is arranged a certain distance from the grounding surface.

2. The transponder unit according to claim 1, wherein
the grounding surface is realized in a planar fashion.

3. The transponder unit according to claim 1, wherein
the grounding surface is realized in a grid-like fashion.

4. The transponder unit according to claim 1, wherein
the antenna is realized in the form of a metallic strip and arranged in the interior of the upper housing part in accordance with the surface structure.

5. The transponder unit according to claim 1, wherein
the antenna is realized in the form of a metallic strip and arranged on a spaced-apart web on the lower housing part.

6. The transponder unit according to claim 1, wherein
the antenna is realized in a meander-shaped fashion.

7. The transponder unit according to claim 1, wherein
the data stored in the transponder IC can be transmitted to the antenna via a coupling loop, wherein the transponder IC is arranged in the immediate vicinity of the antenna.

8. The transponder unit according to claim 1, wherein
one respective conductor element extends from the antenna to the transponder IC and one conductor element extends from the ground ing surface to the transponder IC.

9. The transponder unit according to claim 1, wherein
the web for the antenna is spaced apart from the lower housing part by means of spacer elements.
